(19) United States
(12) Patent Application Publication
(10) Pub. No.: US 2023/0241813 A1
(43) Pub. Date: Aug. 3, 2023

(54) LOW DENSITY POLYETHYLENE FOAM WITH EVACUATED CLOSED CELLS AND HAVING TORTUOUS PATHS OF THERMAL AND ACOUSTIC CONDUCTIVITY

(71) Applicant: Innovative Designs, Inc., Pittsburgh, PA (US)

(72) Inventor: Joseph Riccelli, Pittsburgh, PA (US)

(21) Appl. No.: 18/132,831

(22) Filed: Apr. 10, 2023

Related U.S. Application Data
(63) Continuation-in-part of application No. 17/989,913, filed on Nov. 18, 2022.
Application No. 17/989,913 is a continuation-in-part of application No. 16/944,627, filed on Jul. 31, 2020, now Pat. No. 11,623,375.
Application No. 16/944,627 is a continuation of application No. 15/610,175, filed on May 31, 2017, now abandoned.
Application No. 15/610,175 is a continuation-in-part of application No. 16/944,627, filed on Jul. 31, 2020, now Pat. No. 11,623,375.
(60) Provisional application No. 62/343,309, filed on May 31, 2016.

(51) Int. Cl. B29C 44/34; C08J 9/18; B01D 19/00; C08J 9/14; C08J 9/00; B29C 44/56; C08J 9/228; B29C 44/50; B29K 105/00; B29K 105/04; B29K 23/00

(52) U.S. Cl. CPC B29C 44/3461; C08J 9/18; B01D 19/0005; C08J 9/141; C08J 9/0023; B29C 44/5609; C08J 9/228; B29C 44/3453; B29C 44/505; B29K 2105/0005; C08J 2323/06; B29K 2105/046; B29K 2023/0633; B29K 2023/06; C08J 2203/14; B29K 2995/0063; C08J 2201/03; C08J 2205/052

(57) ABSTRACT

A perforated expanded low density polyethylene foam layer, wherein in the expanded low density polyethylene layer at least 80% of the blowing agents are dissipated from closed cells within the expanded low density polyethylene layer forming evacuated closed cells whereby a partial vacuum is formed within the closed cells of the low density polyethylene layer.

### RELATED APPLICATIONS

The present invention is a continuation in part of U.S. patent application Ser. No. 17/989,913 filed Nov. 18, 2022 and which published Mar. 26, 2023 as Publication Number 2023-0084266 which application and publication are incorporated herein by reference.

The present invention is a continuation in part of U.S. patent application Ser. No. 16/944,627 filed Jul. 31, 2020 and which published Feb. 11, 2021 as Publication Number 2021-0039289 which application and publication are incorporated herein by reference.

U.S. patent application Ser. No. 16/944,627 is a continuation of U.S. patent application Ser. No. 15/610,175 (now abandoned), filed May 31, 2017 and which published as Publication Number 2018-0001522 on Jan. 4, 2018, which application and publication are incorporated herein by reference.

U.S. patent application Ser. No. 15/610,175 claims priority of U.S. Provisional Patent Application Ser. No. 62/343,309 titled “Process for Forming Closed Cell Expanded Low Density Polyethylene Foam and Products Formed Thereby” filed May 31, 2016 which application is incorporated herein by reference.

### BACKGROUND OF THE INVENTION

### 1. Field of the Invention

The present invention relates to a low density polyethylene foam with evacuated closed cells and having tortuous paths of thermal and acoustic conductivity, house wrap and general insulating and soundproofing material formed of the same, and process for making the same.

### 2. Background Information

### Low-Density Polyethylene Foam

Low-density polyethylene (LDPE) is a thermoplastic made from the monomer ethylene. It was produced in 1933 by Imperial Chemical Industries using a high pressure process via free radical polymerization. Polyethylene foam, also known as PE foam and PEF, is a semi-rigid, open or closed-cell type of foam with a near-infinite amount of applications.

Foams range in consistency from rigid materials suitable for structural use to flexible substances for soft cushions and packaging materials. These foams range in cellular formation from open or interconnecting-cell foams to closed or uni-cell foams. The cell structure may range from large to fine. Electrical, thermal, mechanical, and chemical properties can be varied within wide limits depending on the thermoplastic resin composition and the method chosen to create the foam. Traditional foamed thermoplastics range in density anywhere from about 10 kg/m³ to over 1,000 kg/m³, although the latter perhaps more properly are called microcellular structures. True foams are considered to have a density of less than about 800 kg/m³.

Many methods have been developed for the manufacture of foamed thermoplastics. See for example, in U.S. Pat. Nos. 6,350,512, 6,303,666, 5,844,009, 5,554,661, 5,462,974, 5,348,984, 5,059,376, 5,034,171, 4,952,352, 4,746,564, 4,649,001, 4,464,484, 4,347,329, 4,251,584, 4,214,054, 4,120,923, 4,110,269, 3,966,363, 3,810,964, and 3,067,147 which are incorporated herein by reference. The methods generally can be classified into three groups: 1) methods for adding a gaseous “blowing agent” to the thermoplastic during processing, 2) methods for producing a gaseous blowing agent in the thermoplastic during processing, and 3) methods for forming a thermoplastic mass from granules to obtain a cellular structure. Similar blowing agents sometimes are used in the various methods to produce foams. However, it has been proposed that the effectiveness of a particular blowing agent varies considerably depending on the thermoplastic resin composition, the method chosen, the process conditions, the additives used, and the product sought.

### House Wrap Insulation

House wrap is a worldwide multi-billion dollar yearly industry. The phrase “House wrap” (also called “housewrap”) has been defined as inclusive of all synthetic materials effectively designed for the replacement of traditional sheathing tar paper. These materials are all lighter in weight and usually wider than asphalt designs, so contractors can apply the material much faster to a house shell. A conventional house wrap is described as functioning as a moisture barrier, preventing rain from getting into the stud wall construction while allowing moisture vapor to pass out from the house's interior living space to the exterior. If moisture from either direction is allowed to build up within stud or cavity walls, mold and rot can set in and fiberglass or cellulose insulation will lose its R-value (a measure of the efficiency of the insulation) due to heat-conducting moisture.

Conventional house wraps have been described as broadly including (1) asphalt-impregnated paper or fiberglass; (2) micro-perforated, cross-lapped films; films laminated to spun-bond non-woven materials; (3) films laminated or coated to polypropylene woven materials and calendered, wet-laid polyethylene fiber.

House wrap is generally described as requiring both a waterproof aspect and it must have a high moisture vapor transmission rate (MVTR) to be effective. It must also take handling abuse during installation and it is helpful if it is resistant to UV light. House wrap is often left exposed for some time after construction, awaiting exterior sheathing installation. House wrap is generally installed over the sheathing and behind the exterior siding. Siding can be vinyl, wood clapboard, and cedar shingles or brick facade. In all cases, the house wrap, generally, is the last line of defense in stopping incoming water or exterior water condensation from getting into the wooden stud wall.

For a general background and description of house wraps, see the June 2000 Department of Energy (DOE) publication (DOE/GO10099-769) entitled “Weather Resistant Barriers: How to Select and Install Housewrap and Other Types of Weather Resistant Barriers”

It is known to use micro-porous polyolefin films in house wrapping applications. One commercially available film heretofore used as a house wrap is made of high density polyethylene (HDPE) flash spun into fibers and pressed to form the film. The resulting flash-spun HDPE film has been described as suffering from both a high air permeability and a relatively low tear strength. Thus, such house wrap is subject to damage during shipment and installation.

Another commercially available film employed as a house wrap is melt blown, spun-bonded polyethylene. Like the flash-spun HDPE fiber film, the spun-bonded polyethylene has been described as providing a high permeability to air and even worse tensile properties, i.e. break strength, tear strength and puncture resistance. Thus, there is an unfilled need for a house wrap with both “breathability” and good physical and tensile properties.

U.S. Pat. No. 4,929,303 discloses a house wrap formed of a composite breathable film comprising a breathable polyolefin film heat laminated to a non-woven HDPE fabric. The breathable film is prepared by melt embossing a highly filled polyolefin film to impose a pattern of different film thickness therein, and stretching the embossed film. The non-woven fabric is made by cross-laminating HDPE fibers at the crossing points to form a thin open mesh fabric, and co-extruding a heat seal layer thereon. The composite is made by heat laminating the breathable film to the heat seal layer of the fabric.

The DuPont Company has long promoted its TYVEK® brand of house wrap. The TYVEK® brand of house wrap is sometimes described as being “a sheet of very fine, high-density polyethylene fibers”. It has been suggested that the sheet is produced by hot calendering a web made by a flash-spun process where polyolefin polymer is converted into three-dimensional networks of thin continuous interconnected ribbons called film-fibers or plexi-filaments. This process is asserted to be disclosed in U.S. Pat. Nos. 3,081,519, 3,442,740, and 3,169,899.

U.S. Pat. No. 4,900,619 discloses a translucent non-woven fabric composite, suitable for use as a house wrap, wherein the composite comprises a melt-blown fabric layer laminated to a reinforcing fabric layer and may include tacking strips. The composite may be prepared by calendering a melt-blown fabric and a reinforcing fabric together in a nip equipped with a resilient roll.

U.S. Pat. No. 7,148,160 discloses a composite sheet material useful as a house wrap that is water vapor permeable and substantially liquid water impermeable, in which the composite sheet material includes an outer non-woven fiber layer, a film, and a reinforcing layer.

U.S. Pat. No. 7,393,799 discloses composite sheet material that is moisture vapor permeable and substantially liquid impermeable, the composite sheet material including as layers a lightweight, non-wet laid polyester nonwoven, a polyurethane breathable film, a polymer-coated, high tenacity polyester mesh, and a lightweight, non-wet laid, polyester nonwoven material. The material is also abrasion, tear, mildew and fire resistant.

U.S. Pat. No. 5,308,691 discloses a “controlled porosity composite sheet” useful as a house wrap that comprises a melt-blown polypropylene fiber web having a spun-bonded polypropylene fiber sheet laminated to at least one side thereof.

Some commercially available house wraps are three-dimensionally textured to better channel intruding water away from the structure. Like their smooth-faced predecessors, these permeable products also diffuse moisture vapors from inside the structure. For example, the GREENGUARD'S RAINDROP™ brand house wrap is non-perforated cross-woven (breathable) coated polyolefin scrim wherein woven black vertical strands create vertical grooves to direct water down. Manufacturing giant DuPont introduced TYVEK DRAINWRAP™ in 2004 that was made of the same non-woven material as its TYVEK® Home wrap, and wherein it has vertical grooves.

The WEATHERTREK™ brand house wrap by Valeron Strength Films, has a non-directional “pebbled” texture finish to funnel water, wherein, because of its overall pattern, it can be installed in any direction, which may save installation time, versus those with vertical channels. Its rough, crush-resistant texture creates a standoff property to allow an air space between sheathing and siding.

As a further type of house wrap, foil-faced house wraps have been designed, such as SUPER R PREMIUM™ brand “radiant” barrier from Innovative Insulation and Low-E™ brand house-wrap from Environmentally Safe Products. There is some question of the effectiveness of the foil as a radiant barrier after the outer cladding is attached to the building.

Despite the wide commercial acceptance and application of currently available house wraps there have been those that have objected to their viability and efficiency. Joseph Lstiburek of the Building Science Corporation issued a report entitled “Problems with Housewraps” in 2001 in which he noted that “the energy aspects of [currently commercially available] housewraps are vastly overstated”.

As noted above expanded low density polyethylene foam has a wide number of applications. The inventor of the instant invention utilized LDPE foam in the construction of a house wrap as disclosed in patent publication 2010-0154338, which is incorporated herein by reference. The inventor of the instant invention utilized LDPE foam in the construction of a composite fabric material as disclosed in U.S. Pat. Nos. 8,429,764 and 9,573,340, which are incorporated herein by reference. In house wrap applications in particular, and in other applications such as fabrics used for outerwear, the exceptional thermal insulating properties of LDPE foam is advantageous, but there is a desire to further improve upon these characteristics.

The above identified patents are incorporated herein by reference in their entireties. These patents describe calendering techniques and composite layer attachment techniques that can be utilized in the present invention as will be apparent form a review of the following description.

### CONCLUSIONS

There remains a need in the industry to develop closed cell expanded low density polyethylene foam with superior thermal insulation characteristics and develop a process for making the same. Additionally there is a need to significantly improve upon the operational characteristics of house wraps. It is an object of the present invention to address the deficiencies of the prior art discussed above and to provide an efficient house wrap that can be produced in a cost effective manner.

### SUMMARY OF THE INVENTION

The various embodiments and examples of the present invention as presented herein are understood to be illustrative of the present invention and not restrictive thereof and are non-limiting with respect to the scope of the invention.

It is an object of the present invention to eliminate the above-mentioned drawbacks by providing a foamed, expanded low density polyethylene possessing superior thermal resistance characteristics. The process of the present invention includes the steps of: providing a mixture including low density polyethylene pellets and an effective amount of glycerides as a degassing agent; adding a primary blowing agent comprising one of liquid propane, liquid butane, and combinations thereof, to the mixture and gasifying the blowing agent to expand the low density polyethylene; forming the expanded low density polyethylene into sheets, curing the expanded low density polyethylene until 80%, preferably at least 95% and more preferably at least 99% of the primary blowing agent is dissipated from cells within the expanded low density polyethylene forming evacuated closed cell low density polyethylene sheets.

The process of forming low density expanded polyethylene foam according to according to one aspect of the invention provides wherein the effective amount of glyceride is about 0.3-5%, preferably 1-4%, and more preferably about 2.5% of the low density polyethylene by weight.

The process of forming low density expanded polyethylene foam according to one aspect of the invention provides that the curing step is at least two days, preferably at least 15 days, and generally about 30 days, before closed cell low density polyethylene sheets are subsequently processed.

One aspect of the invention provides a process of forming low density expanded polyethylene foam comprising the steps of: providing a mixture including low density polyethylene pellets and hydrocarbon scavenger additive in an amount of about 0.3-5% of the low density polyethylene by weight; adding a primary blowing agent comprising one of liquid propane, liquid butane, and combinations thereof, to the mixture and gasifying the blowing agent to expand the low density polyethylene; forming the expanded low density polyethylene into sheets; and curing the expanded low density polyethylene until 80% of the primary blowing agent is dissipated from cells within the expanded low density polyethylene forming closed cell low density polyethylene sheets. The process of forming low density expanded polyethylene foam according to one aspect of the invention provides wherein the hydrocarbon scavenger additive include glycerides, activated carbon, sodium bicarbonate, graphite, silica gels, zeolites, diatomaceous earth, petro-gels, and mixtures of the above.

One aspect of the invention provides an expanded low density polyethylene sheets in which at least 80%, preferably at least 95% and more preferably at least 99% of the blowing agents are dissipated from cells within the expanded low density polyethylene forming evacuated closed cell low density polyethylene sheet.

According to one non-limiting embodiment of the present invention, a composite house wrap is provided with at least three integral sections or layers. The first or front or outer layer is a reinforcing grid or mesh that functions to form a drainage plane between the house wrap and the outer cladding and thus it will face the outside cladding. The second or middle layer is a non-perforated breathable, barrier film, such as a nonwoven film layer, a PTFE film layer, polyethylene (PE) film layer or polyurethane (PUR) film layer, which is bonded to the first layer, such as through thermal bonding. The term breathable references a structure that allows water vapor transmission. The term barrier with regard to the film layer references that it is resistant or impervious to liquid transmission. The third or rear layer is an expanded low density polyethylene sheet or layer with evacuated closed cells in which at least 80%, preferably at least 95% and more preferably at least 99% of the blowing agents are dissipated from the closed cells.

One aspect of the invention provides a house wrap for a building comprises a first reinforcing layer providing a drainage plane for the house wrap and configured to face the outside of the building; a second layer including a breathable, non-perforated barrier film bonded to the first layer; and a third layer including a perforated expanded low density polyethylene foam layer is bonded to the middle layer, wherein in the expanded low density polyethylene layer at least 80% of the blowing agents are dissipated from closed cells within the expanded low density polyethylene layer forming evacuated closed cells whereby a partial vacuum is formed within the closed cells of the low density polyethylene layer.

The house wrap according to the present invention will provide barrier protection plus moisture vapor transmission and yield an insulation R-value of at least R6. This house wrap is specifically designed to add enhanced insulating characteristics as opposed to conventional house wraps, while maintaining a cost effective and easy to handle house wrap.

These and other advantages of the present invention will be clarified in the description of the preferred embodiments taken together with the attached figures.

### BRIEF DESCRIPTION OF THE FIGURES

FIG. 1 is a schematic plan view of a system for implementing the process of the present invention; and

FIG. 2 is a schematic top view of the system of FIG. 1 taken in the direction of the arrow II shown in FIG. 1.

FIG. 3 is a composite house wrap formed of low density polyethylene foam with evacuated closed cells and having tortuous paths of thermal conductivity in accordance with one embodiment of the present invention;

FIG. 4 is a schematic cross section of the house wrap with high insulating properties in accordance FIG. 3;

FIG. 5 is a schematic cross section of a modified version of house wrap with high insulating properties in accordance FIG. 3; and

FIG. 6 is a schematic cross section of a modified version of house wrap with high insulating properties in accordance FIG. 3.

### DESCRIPTION OF THE PREFERRED EMBODIMENTS

In summary, one object of the present invention relates to a process of forming expanded closed cell low density polyethylene foam comprising the effective steps of: providing a mixture including low density polyethylene pellets and an effective amount of glycerides as a degassing agent; adding a primary blowing agent comprising one of liquid propane, liquid butane, and combinations thereof, to the mixture and gasifying the blowing agent to expand the low density polyethylene; forming the expanded low density polyethylene into sheets, curing the expanded low density polyethylene until 80% of the primary blowing agent is dissipated from cells within the expanded low density polyethylene forming closed cell low density polyethylene sheets.

Low density polyethylene (LDPE) is a thermoplastic, with the formula (C₂H₄)ₙ, which is defined by a density range of 0.910-0.940 g/cm³. It is un-reactive at room temperatures, except by strong oxidizing agents. It is known as being quite flexible, and tough. LDPE has more branching (on about 2% of the carbon atoms) than high density polyethylene (HDPE).

The LDPE molecules are less tightly packed and less crystalline than HDPE because of the side branches, and thus its density is lower. It is typically found as a powder or pellet forms and has a CAS #9002-88-4. U.S. suppliers polyethylene include of AccuStandard Inc; Aceto Corporation; AK Scientific, Inc.; Cambridge Isotope Laboratories, Inc.; CarboMer, Inc.; Dow Chemical Company; EMCO Industrial Plastics, Inc.; HBCChem, Inc.; Pressure Chemical Co.; Scientific Polymer Products, Inc.; and Waterstone Technology, LLC.

Glycerides, more correctly known as acylglycerols, are esters formed from glycerol and fatty acids. Glycerol has three hydroxyl functional groups, which can be esterified with one, two, or three fatty acids to form monoglycerides, diglycerides, and triglycerides.

A monoglyceride is a glyceride in which each glycerol molecule has formed an ester bond with exactly one fatty acid molecule. The more formally correct terms in modern convention are acylglycerol and monoacylglycerol. Any monoacylglycerol is either a 1-monoacylglycerol or a 2-monoacylglycerol, depending on the position of the ester bond on the glycerol moiety. 1-monoacylglycerides possess a chiral centre at carbon 2.

A diglyceride, or diacylglycerol (DAG), is a glyceride consisting of two fatty acid chains covalently bonded to a glycerol molecule through ester linkages. One example is 1-palmitoyl-2-oleoyl-glycerol, which contains side-chains derived from palmitic acid and oleic acid. Diacylglycerols can also have many other combinations of fatty acids attached at either the C-1 and C-2 positions or the C-1 and C-3 positions. 1,2 di-substituted glycerols are always chiral, 1,3 di-substituted glycerols are chiral if the substituents are different from each other. Acceptable diglycerides and monoglycerides suitable for the present invention include those under CAS #91052-47-0, 10303-53-4 and 41670-62-6.

A triglyceride (TG, triacylglycerol, TAG, or triacylglyceride) is an ester derived from glycerol and three fatty acids (tri-+glyceride). There are many different types of triglyceride, with the main division being between saturated and unsaturated types. Saturated fats are “saturated” with hydrogen—all available places where hydrogen atoms could be bonded to carbon atoms are occupied. These have a higher melting point and are more likely to be solid at room temperature. Unsaturated fats have double bonds between some of the carbon atoms, reducing the number of places where hydrogen atoms can bond to carbon atoms. These have a lower melting point and are more likely to be liquid at room temperature. Acceptable triglycerides suitable for the present invention include those under CAS #65381-09-1 and 97794-26-8.

Propane is a three-carbon alkane with the molecular formula C₃H₈, a gas, at standard temperature and pressure, but compressible to a transportable liquid. A by-product of natural gas processing and petroleum refining, it is one of a group of liquefied petroleum gases (LP gases). The others include butane, propylene, butadiene, butylene, isobutylene and mixtures thereof. Propane has a Cas #74-98-6.

Butane is an organic compound with the formula C₄H₁₀ that is an alkane with four carbon atoms. Butane is a gas at room temperature and atmospheric pressure. The term may refer to either of two structural isomers, n-butane or isobutane (or “methylpropane”), or to a mixture of these isomers. In the IUPAC nomenclature, however, “butane” refers only to the n-butane isomer (which is the isomer with the unbranched structure). Butanes are highly flammable, colorless, easily liquefied gases. Butane has a Cas #106-97-8.

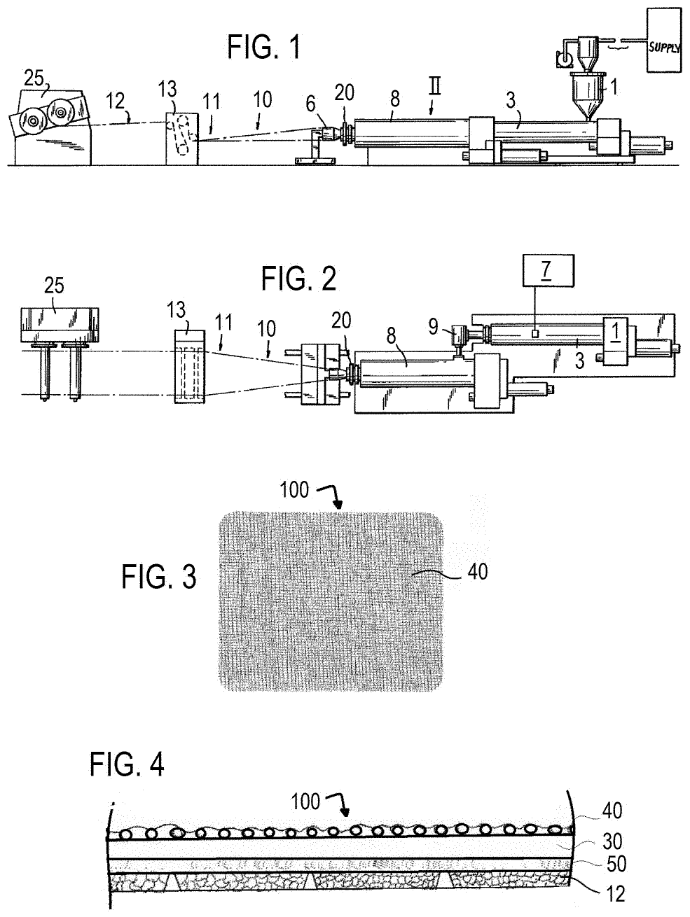

In the present invention FIG. 1 is a schematic plan view of a system for implementing the process of the present invention; and FIG. 2 is a schematic top view of the system of FIG. 1 taken in the direction of the arrow II shown in FIG. 1.

In accordance with the present invention, and as schematically shown in the drawings, a low density polyethylene prepared by conventional process is mixed, for example in a hopper 1, with an effective amount of a glyceride, preferably a monoglyceride, forming a degassing agent, to form a dry mixture (as discussed below, in alternative embodiments the dry mix includes a preliminary auxiliary blowing agent, a surface activation agent, a separation agent, a fire retarding agent, a crosslinking agent to improve strength of the foam, a coloring agent and an anti-discoloration agent). The amounts of the ingredients are generally expressed relative to the amount of the low density polyethylene. The present invention provides an effective amount of glyceride to be about 0.3-5% of the low density polyethylene by weight, and more preferably about 1-4% of the low density polyethylene by weight, and more preferably about 2.5% of the low density polyethylene by weight.

The degassing agent, such as glycerides, may be referenced as a hydrocarbon scavenger additive and the low density polyethylene may be mixed, for example in a hopper 1, with an effective amount of hydrocarbon scavenger additive which can include other materials than glyceride. Hydrocarbon scavenger additives include glycerides, activated carbon, sodium bicarbonate, graphite, silica gels, zeolites, diatomaceous earth, and polymer absorbents called “petrogels”: polyolefin-based hydrophobic absorbents that demonstrate selective absorption of hydrocarbon (oil) molecules in water, and mixtures of the above, with glycerides and glyceride containing mixtures being preferred. Mixed into the low density polyethylene hydrocarbon scavenger additives that react with the expanded low density polyethylene in a manner that causes short chain molecules to have an affinity for hydrocarbon structures of the primary blowing agent, and draw these variants to oxygen rich environments, namely to the exterior of the composite structure. As the cells deplete, the process slows accordingly and consumes more time to evacuate the remaining hydrocarbon based molecules than when the process was initiated. The present invention provides an effective amount of hydrocarbon scavenger additives to be about 0.3-5% of the low density polyethylene by weight, and more preferably about 1-4% of the low density polyethylene by weight, and more preferably about 2.5% of the low density polyethylene by weight.

The dry mixture is conveyed to a closed heat tunnel 3, where it is processed possibly in a series of stages at different temperatures. A conventional thermocouple control box can be used to maintain a particular required temperature in each of the processing stages in the heat tunnel 3.

A conventional coil or screw conveys the mixture through the heat tunnel 3. A single screw conveyor is preferred as it yields a homogeneous mixture without damage to the mixture or batch that is possible with double screw systems. In the heat tunnel 3, the dry mixture is heated at a temperature of about 170° C. to form a melted and softened polyethylene mass. In the heating tunnel 3, the primary blowing agent is introduced at 7 into the polyethylene mass to subject the mass to cell expansion. This primary blowing agent is introduced at a suitable pressure.

The preferred primary blowing agent is propane, however butane or a mixture of propane and butane may be used. When using liquid propane as the primary blowing agent an effective amount of propane is about 15-50% of the low density polyethylene by weight, and more preferably about 20-40% of the low density polyethylene by weight, and more preferably about 24-28% of the low density polyethylene by weight. It is possible that other liquid petroleum gases and mixtures thereof may be utilized but propane, butane and mixtures thereof have been proven to be effective. Another advantage to using liquid propane (or butane) is its inexpensiveness and availability.

After the introduction of the primary blowing agent and expansion of the polyethylene mass, the mass is subjected, within the heating tunnel, to a temperature of about 100° C., wherein it begins to cool. Treatment of about 100° C. prepares the mass for proper and efficient cutting. This completes the heating and blowing process.

The expanded mass continues its travel through a second portion 8 of the heating tunnel which typically does not have any coil or screw therein. In this second portion 8 of the heating tunnel, a desired quantity of the expanded mass is cut, for example, by a conventional cutting blade 9. The expanded mass is still in a softened state. The desired quantity depends, of course, on the size of the final sheet or tube desired. The cut, expanded mass is next subjected to a temperature of about 105° C. in the heating tunnel and extruded through a die and mandrel 20 into a free expansion zone 10 and cooling zone 11 at atmospheric pressure and room temperature. The temperature of the mass should be raised slightly after cutting because a temperature of about 100° C. is too cool for proper extruding. After extrusion, the foamed polyethylene mass expands naturally in the atmosphere, but not explosively, and cools at room temperature for a short period, e.g., a few seconds. The cooling mass of polyethylene is then formed into a sheet 12 by conventional rollers 13 the thickness being determined by the desired end use of the product.

The sheet 12 can then be wound on rolls 25 after which it is maintained at room temperature (typically 20° C. to 30° C., preferably about 25° C.) for a curing period of 1-30 days. The cells of the expanded mass are degassed as entrapped blowing agent work its way out of the cells. Typically 80% of the primary blowing gas is degassed from the cells and not in the sheet within a few days, namely at least two days, and at least 95% of the primary blowing gas is degassed from the cells and not in the sheet by 15 days and more than 99% (actually more than 99.9%) of the primary blowing gas is degassed from the cells and not in the sheet by 30 days. The closed cell low density polyethylene sheet of the present invention is available for subsequent processing into other products such as a house wrap or fabric sheet when 80% of the primary blowing agent is degassed form the sheet 12. The sheet 12 must be sufficiently degassed, namely at least 80%, preferably at least 95% and more preferably at least 99% of the primary blowing agent before the sheet 12 is subsequently processed.

Testing of the sheet formed according to the present invention using propane as the primary blowing agent with a curing time of 15 days yielded no trace amounts of butane in the samples tested. The testing was performed by Vaper Analysis by the Material Characterization Services LLC at the Oneida Research Services facility in Englewood Colorado in August 2016. The test was performed three times and utilized two control samples. The concentrations were measured in parts per million, wherein measurements of Argon and CO2 being registered in separate control samples at levels as low as 7 parts per million evidenced the accuracy of the testing, and 0 parts per million of the blowing agent were found in the samples of the invention sheet 12 tested. With the accuracy of the testing performed this yields a degassing of greater than 99.9993% of the primary blowing agent.

During the mixing step, additives can be added in appropriate amounts to impart additional characteristics to the final product, such as a fireproofing anti-inflammatory agent such as tin or a bromine based flame retardant. A further additive include about 0.1% to about 0.2% by weight of the polyethylene of cross linking agents such as azobisformamide (ABFA) or dicumyl peroxide, which can be added in powder form to increase the resistance of the final product to tearing, as well as about 0.1% of an ultra-violet absorber to prevent discoloration. Optionally, a separating agent may be included in the initial mixing step. A suitable separating agent to be initially mixed with the low density polyethylene is ZnC. The separating agent, added preferably in powder form, aids in preventing the LDPE from sticking to the coil 5 or walls of the heating tunnel 3. The amount of separating agent added is substantially about 0.3% by weight of the polyethylene. The additives to the dry mix may be in the form of a known Masterbatch (MB) component, which generally is a solid or liquid additive for plastic used for coloring plastics (color masterbatch) or imparting other properties to plastics (additive masterbatch). Masterbatch is a concentrated mixture of pigments and/or additives encapsulated during a heat process into a carrier resin which is then cooled and cut into a granular shape. Color Masterbatch, generally 1-5% by weight of the polyethylene, allows the processor to color raw polymer economically during the plastics manufacturing process.

Additionally the dry mix can include an auxiliary preliminary blowing agent. Suitable auxiliary preliminary blowing agents to be initially mixed with the low density polyethylene, preferably in powder form, include axodicarbonamide N,N′-dinitrosopentamethylene-tetramine, (commercially-available as Unicel NDX, gasifying temperature of about 195° C.), and 4,4′ Oxybis (commercially-available as Celogen OT, gasifying temperature of about 150° C. Azodicarbonamide, or azo(bis) formamide, is a chemical compound with the molecular formula C₂H₄O₂N₄ with a Cas #123-77-3 and a gasifying temperature of about 195° C. N,N′-dinitrosopentamethylene-tetramine has a Cas #101-25-7 and also has a gasifying temperature of about 195° C. 4,4′ Oxybis is a chemical compound with the molecular formula C₄H₁₀O₃ with a Cas #111-46-6 and a gasifying temperature of about 150° C. The amount of auxiliary preliminary blowing agent added is about 0.5-2%, and preferably about 1% by weight of the polyethylene. Azodicarbonamide is the preferred initial auxiliary blowing agent.

With the use of an initial auxiliary blowing agent, a surface activation agent may also be initially mixed with the low density polyethylene, preferably in powder form, and suitable surface activation agents include zinc oxide, cadmium oxide and calcium carbonate. The surface activation agent is added in an amount ranging from about 0.1 to about 0.2% by weight of the polyethylene. The surface activation agent performs several important functions. First, it activates the blowing process while preventing too rapid an expansion of the LDPE cells during initial blowing. Secondly, it keeps the temperature in the heating tunnel 3 down during the initial blowing process. For example, where azodicabonamide is used as the auxiliary blowing agent, the surface activation agent assists in maintaining a temperature of around 150° C. in the relevant stage of the heating tunnel 3. Absent this agent, the gasified blowing agent would raise the temperature to around 196° C.

The use of the auxiliary blowing agent allows the mass to be heated and mixed to form a homogeneous mixture then heated to gasify the preliminary auxiliary blowing agent in a first blowing step, then the partially expanded mass is generally cooled prior to being reheated to the appropriate temperature for the blowing with the primary blowing agent discussed above.

With the use of the use of the auxiliary blowing agent the total time in the heating tunnel 3 takes generally from about 30 minutes to about 1 hour to complete. The auxiliary blowing agent, if used, can be considered as part of the primary blowing agent for degassing purposes whereby the sheet 12 must be sufficiently degassed, namely at least 80%, preferably at least 95% and more preferably at least 99% of the blowing agents (including both the primary and the auxiliary blowing agents if an auxiliary blowing agent is used) before it is subsequently processed.

The foam 12 of the invention has a variety of applications such as a house wrap discussed in detail below. Another particularly useful product is utilizing the LDPE foam 12 in the construction of a composite fabric material as disclosed in U.S. Pat. No. 8,429,764, which is incorporated herein by reference.

### House Wrap

The closed cell expanded low density polyethylene sheet 12 formed by the present invention can be formed into a variety of products and it is particularly well suited for products utilizing high thermal resistance (without exposure to extreme high temperatures that would melt the foam) and flexibility. One of these include a composite house wrap 100 as outlined herein and shown in FIGS. 3-6, the primary embodiment shown in FIGS. 3-4.

Without being limited to theory it is believed that the process of forming the low density expanded polyethylene foam 12 of the invention create a firmer cell that keeps the cell structure from collapsing and allows the blowing agent to fill the cells and then evacuate, through hydrocarbon-philic chemistry, most of the cell structures without collapsing them and, therefore, yields an effectively evacuated cell or vacuum (or technically partial vacuum). A vacuum is the best form of insulation and the process results in an extremely thin material which is highly insulating as the numerous cell walls create a tortuous path for thermal conductivity. By creating micro cells that are semi-rigid and have or form a vacuum, the house wrap 100 becomes advantageous for the building industry. With stacking these “evacuated cells” on top of each other (multiple layers 12 and/or thicker layers 12) and creating a barrier to trap heat or air conditioned air. A half inch multiple extruded composite house wrap 100 produces an R30 product.

In summary, one aspect of the present invention relates to a composite house wrap 100 provided with integral sections or layers 50, 40, 30 and 12 as described below. The house wrap 100 according to the present invention shown in FIGS. 3-4 will provide barrier protection plus moisture vapor transmission and an insulation R-value of approximately R6 or higher.

The terms about or approximately or similar terms should be read as meaning within ten percent within this application. This house wrap 100 is specifically designed to add enhanced insulating characteristics as opposed to conventional house wraps, while maintaining a cost effective and easy to handle house wrap.

As with most extruded material and prior art LDPE, the LDPE layer(s) 12 of the house wrap 100 utilizes a gas injection process to create a structure of randomized gas filled spheres throughout the material of the sheet 12. However, unlike any other extruded material or other LDPE structures, the injection gas used to create the gas-filled spheres within the layer 12 is completely expunged from the material during the curing process, thereby creating a unique extruded material. The material has been tested to be comprised of a countless number of evacuated cells without even a trace amount of the injection or blowing gas used in the creation of the material.

There is a class of insulation materials known as mass insulation. The measured insulation magnitude of mass insulation materials is referred to as an R-value. The R-value is dependent upon the thermal conductivity [W/(mOK)] of the material and the path travel distance of the heat. It is for this reason that the thickness of mass insulation is commonly treated or accepted as a linear function with respect to the material's R-value. The reason for this treatment or acceptance is due to the fact that very frequently heat traverses through mass insulation as a linear function of its thickness. Hence, R-value is a linear function of a material's thickness. The material structure description of the sheet 12 of the invention reveals that a more accurate classification for this insulation material is “absence of mass” insulation, which is due to the fact that its structure consists of a countless number of evacuated cells that are devoid of mass, namely elemental and molecular gases. The material is essentially comprised of randomized structures of the evacuated cells.

Due to the cells' evacuated state, their thermal conductivity across the cell approaches the value of a vacuum, which is zero. The result is that each evacuated cell acts as a thermos-physical barrier to the conduction of heat through the material. This interrupts the natural directional flow of heat, and introduces a three-dimensional non-linear tortuous path in which the heat traverses through the material through the cell walls. It is important to realize that the tortuous path shown in the figures only illustrates a two-dimensional tortuous path when, in fact, it is actually a significantly more complex three-dimensional tortuous path. It is key to understand that the R-value for “absence of mass” insulation material is greatly enhanced by the length of the tortuous path traversed by the heat (thermal energy).

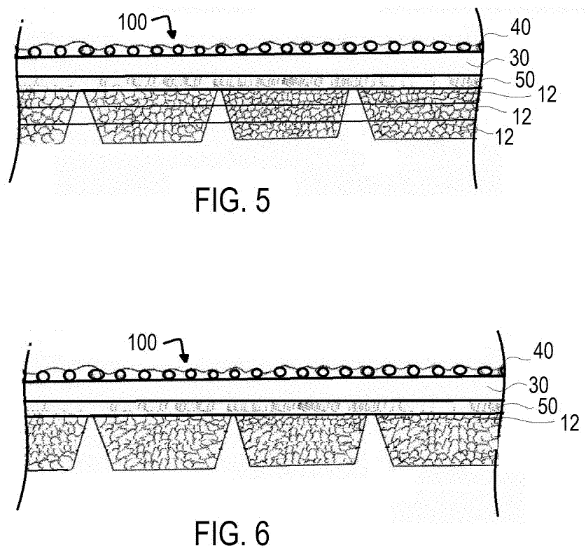

The house wrap 100 has a total thickness of generally less than 80 mils for the embodiment of FIGS. 3-4 and effectively always less than 175 mils for the embodiments of FIGS. 5-6. The house wrap 100 can be attached to a building in any conventional fashion, such as nail guns, or the like. The house wrap 100 has the flexibility and durability that is comparable to, and actually better than many, existing commercial house wraps. The house wrap 100 of the present invention can also be used as a roof paper or roof underlay.

The first or front or drainage plane layer 40 is a reinforcing grid or mesh that functions as a drainage plane and will face the outside cladding. The mesh layer 40 can be formed effectively from polyethylene, however substantially any material providing the structural equivalent and suitable for the desired work environment could be used. The thickness of the mesh layer 40 and barrier layer is no greater than about 0.9 millimeters or about 35 mils, typically less than 10 mills, generally 8-9 mils. The mesh layer 40 can be formed effectively of a wide variety of grid patterns, even a non-grid pattern of structural as suggested again below.

The front layer 40 serves a drainage function by providing a space for water drainage. Secondly, the front layer 40 serves as a reinforcing member for the house wrap 100 to provide structural integrity to the entire assembly.

The front layer 40 could take other forms, such as spaced ribs or an elongated diamond pattern. Essentially the spaced ribs alternative design would be the mesh layer 40 without the cross bracing. The spaced ribs could be vertical or angled at essentially any angle to form more definitive drainage channels. A “vertical” orientation of such ribs would also allow the house wrap 100 to be easily rolled up in one direction (i.e. rolled about an axis parallel to the ribs). The ribs need not be straight members, but each rib could be a zig-zag or herringbone shaped or diamond shaped construction. The interconnected mesh layer 40 of the preferred embodiment is believed to add structural integrity while still allowing for an efficient drainage plane for the house wrap 100.

The second or middle or barrier film layer 30 is a breathable, non-perforated barrier film 30 which is bonded to the first layer 40 and together have a thickness of no greater than about 0.9 millimeters, generally 8-9 mils as noted. The second or middle layer 30 may be formed of a polyethylene (PE) or a Polyurethane (Pur) material, but a myriad of other breathable film layer materials could be used assuming the cost concerns could be addressed, such as PVC film or polytetrafluoroethylene (PTFE) film. The PE or PUR material are the most cost effective. In one embodiment the film 30 is bonded to the layer 40 through thermal bonding. Other bonding techniques may be used, such as adhesives. The film layer 30 should have acceptable breathability for the field of house wraps.

Collectively the film layer 30 and layer 40 may be tested or evaluated together for forming the house wrap 100. Collectively the film layer 30 and layer 40 should exhibit an ASTM-2273 (2016) test result of greater than 95%. ASTM-2273 represents a standard test method for determining drainage efficiency of exterior insulation and finish system clad wall assemblies. Collectively the film layer 30 and layer 40 should exhibit an air porosity (Gurley Air Porosity—TAPPIT-460 (2016)) of at least two thousand Sec. Collectively the film layer 30 and layer 40 should exhibit a water resistance of at least three hundred CM (AATCC 127 (2016).

The rear or foam layer 12 is a perforated expanded low density polyethylene foam 12 that is formed as noted above, and that is bonded to the middle layer 30, such as through nonwoven layer 50.

The third or rear LDPE foam layer 12 is a perforated, wherein a series of equally spaced perforations may extend through the layer 12. The perforations can be conical which may provide certain advantages to the house wrap 10 of the present invention. However, cylindrical shaped perforations for perforations would also be acceptable. The perforations can be formed on layer 12 through a perforation roller which has a series of perforation pins thereon. For the conical shaped perforations as shown the pins would have a shape similar to the final desired shape of the perforations (with three hole per square inch being a preferred perforation density). The layer 12 can be perforated before it is assembled, or the perforations can be made after the house wrap is assembled.

The foam layer 12 should be about 1-1.1 millimeters (39-43 mils) in thickness, generally less than 45 mils and always less than 75 mils for a conventional house wrap 100 of FIGS. 3-4. This design will provide insulation R-values of R6 or better.

The non-woven layer 50 of two to six mils thickness provides an improved bonding layer or adhesion promoting layer for the barrier film layer 30 and the foam layer 12 and yields improved stability and performance to the house wrap 100. Nonwoven layer 50 is formed from staple fibers, such as polyester fibers, bonded together by chemical, mechanical, heat or solvent treatment. The non-woven layer 50 may be described as denoting a fabric which is neither woven nor knitted.

The FIGS. 3-4 show a house wrap 100 embodiment with a single layer of foam layer 12, however as noted above multiple layers could be used as shown in the embodiment of FIG. 5. A thick house wrap 100 up to ½ inch thick having multiple layers 12 exhibits an R30 value. An extended or thicker foam layer 12 of up to 2.5 millimeters (98 mils) can be formed using the process of the present invention and this is shown in FIG. 6 and represents an alternative method of achieving R-values up to R-30.

The house wrap 100 has qualitatively demonstrated that it can absorb and attenuate sound energy. In other words, it has good sound-deadening properties as a soundproofing substrate. While it may not completely attenuate sound energy, it can deaden or attenuate a good majority of the sound energy that impinges on the house wrap 100.

Sound energy travels as waves and it is a form of mechanical energy whereby molecular vibrations actually cause the sound that is perceived as noise. In order for sound waves to exist, there has to be a medium for them to traverse. The medium can be either a solid, liquid or gas. The medium must have molecules that vibrate in order to create sound.

It is estimated that the volume fraction of the Low Density Polyethylene (LDPE) in the house wrap 100 is 0.46 or 46% by volume, assuming the density of the LDPE is 0.91 grams/cm³. This is based on density data obtained by an independent laboratory. The remaining 54% volume or 0.54 volume fraction of the house wrap 100 consists essentially of a vacuum. Sound waves cannot traverse a vacuum due to the lack of molecular vibrations in a vacuum. This precludes sound waves from traveling through the evacuated cells of house wrap 100. These evacuated cells are essentially a vacuum. Hence, the sound waves can only travel through the LDPE foam medium of the house wrap 100. As a result, there will be a significant attenuation of sound due to house wrap 100 containing a significant amount of evacuated cells. Just like thermal energy traverses in a tortuous path through the house wrap 100, the sound energy will traverse the same tortuous path.

As a result of house wrap 100 having the ability to significantly attenuate sound, having good sound absorption properties and being lightweight, it has the potential to be used in applications other than house wrap and clothing designed for subzero temperatures.

Some of these applications for the house wrap 100 include, but are not limited to motor vehicles, such as automobiles and construction vehicles, trains, airplanes, appliances such as washing machines and air conditioners, commercial and residential structures and office partitions. In the insulating and sound deadening applications like motor vehicles, trains, airplanes, and appliances the scrim layer 40 and barrier layer 30 generally form a mounting of backing layer and could be replaced with a single backing layer where drainage is not a concern. Further if breathability of the material is not a concern the perforations of the foam can be eliminated. However the breathability and drainage features may be useful in some applications and generally a backing for the foam 12 is typically useful such that layers 30 and 40 may indeed be present.

Whereas particular embodiments of the invention have been described above for purposes of illustration, it will be evident to those skilled in the art that numerous variations of the details of the present invention may be made without departing from the spirit and scope of the present invention.

What is claimed is:

1. A low density polyethylene foam sheet having evacuated closed cells forming a tortuous thermal conductive path along the cell walls through the foam layer, wherein the foam layer has an insulating R-Value of at least 2 and wherein at least 80% of the primary blowing agent is dissipated from cells within the expanded low density polyethylene foam forming a evacuated closed cell low density polyethylene sheet.

2. The low density polyethylene foam sheet according to claim 1 wherein the foam sheet is formed as a house wrap including a non-woven layer which is coupled to the barrier film layer.

3. The low density polyethylene foam sheet according to claim 2 wherein the house wrap formed by the foam sheet has an insulating R-Value of at least

4. The low density polyethylene foam sheet according to claim 1 wherein at least 95% of the primary blowing gas is degassed from the cells within the expanded low density polyethylene foam forming a evacuated closed cell low density polyethylene sheet.

5. The low density polyethylene foam sheet according to claim 1 wherein at least 99% of the primary blowing gas is degassed from the cells within the expanded low density polyethylene foam forming a evacuated closed cell low density polyethylene sheet.

6. The low density polyethylene foam sheet according to claim 1 wherein at least 99.9% of the primary blowing gas is degassed from the cells within the expanded low density polyethylene foam forming a evacuated closed cell low density polyethylene sheet.

7. The low density polyethylene foam sheet according to claim 1 wherein at least 40% by volume of the sheet is formed by the interior space of the evacuated cells.

8. The low density polyethylene foam sheet according to claim 1 wherein at least 50% by volume of the sheet is formed by the interior space of the evacuated cells.

9. The low density polyethylene foam sheet according to claim 1 wherein about 54% by volume of the sheet is formed by the interior space of the evacuated cells.

10. A soundproofing device comprising a low density polyethylene foam sheet having evacuated closed cells forming a tortuous thermal conductive path along the cell walls through the foam layer, wherein the foam layer has an insulating R-Value of at least 2 and wherein at least 80% of the primary blowing agent is dissipated from cells within the expanded low density polyethylene foam forming a evacuated closed cell low density polyethylene sheet.

11. The soundproofing device according to claim 10 wherein the foam sheet is formed as a house wrap including a non-woven layer which is coupled to the barrier film layer.

12. The soundproofing device according to claim 11 wherein device has an insulating R-Value of at least 6.

13. The soundproofing device according to claim 10 wherein at least 95% of the primary blowing gas is degassed from the cells within the expanded low density polyethylene foam forming a evacuated closed cell low density polyethylene sheet.

14. The soundproofing device according to claim 10 wherein at least 99% of the primary blowing gas is degassed from the cells within the expanded low density polyethylene foam forming a evacuated closed cell low density polyethylene sheet.

15. An insulating device comprising a low density polyethylene foam sheet having evacuated closed cells forming a tortuous thermal conductive path along the cell walls through the foam layer, wherein the foam layer has an insulating R-Value of at least 2 and wherein at least 80% of the primary blowing agent is dissipated from cells within the expanded low density polyethylene foam forming a evacuated closed cell low density polyethylene sheet.

16. The insulating device according to claim 15 wherein the foam sheet is formed as a house wrap including a non-woven layer which is coupled to the barrier film layer.

17. The insulating device according to claim 16 wherein device has an insulating R-Value of at least 6.

18. The insulating device according to claim 17 wherein at least 95% of the primary blowing gas is degassed from the cells within the expanded low density polyethylene foam forming a evacuated closed cell low density polyethylene sheet.

19. The insulating device according to claim 15 wherein at least 95% of the primary blowing gas is degassed from the cells within the expanded low density polyethylene foam forming a evacuated closed cell low density polyethylene sheet.

20. The insulating device according to claim 15 wherein at least 99% of the primary blowing gas is degassed from the cells within the expanded low density polyethylene foam forming a evacuated closed cell low density polyethylene sheet.
